(19) United States
(12) Patent Application Publication
(10) Pub. No.: US 2005/0223074 A1
(43) Pub. Date: Oct. 6, 2005

(54) System and method for providing user selectable electronic message action choices and processing

(76) Inventor: Robert P. Morris, Ralelgh, NC (US)

Correspondence Address: SAWYER LAW GROUP, LLP, PO BOX 51458, PAL ALTO, CA, 94303, US

(21) Appl. No.: 10/813,715

(22) Filed: Mar. 31, 2004

(51) Int. Cl. G06F 15/16

(52) U.S. Cl. 709/207

(57) ABSTRACT

In a method and system for providing user selectable electronic message action choices and processing, an electronic message for a client is received. Then, it is determined if the electronic message matches at least one criteria of a filter, where at least one action is associated with the filter. If so, a graphic associated with the action is displayed when the electronic message is viewed at the client, and the action is executed if the graphic is selected. In one embodiment, computer code for displaying the graphic is inserted into the electronic message. In this manner, services can be provided at the client without requiring a plug-in to be registered at the client. Additional functionality, services, and/or flexibility can be easily provided.

### FIELD OF THE INVENTION

The present invention relates to electronic message processing, and more particularly to providing user selectable electronic message processing.

### BACKGROUND OF THE INVENTION

The Internet has provided individuals with a wide range of methods for exchanging files and data. Of these, electronic messaging, such as email, is the dominant method for exchanging message and files (data, media, and executable files), with instant messaging growing quickly. These methods were originally designed to send simple text data. They allow files to be transferred as attachments or to be imbedded in a message. Files which are attached to the messages are displayable provided a plug-in is registered with the client. Plug-ins are associated with various types of files by mapping a file's Multipurpose Internet Mail Extensions (MIME) type to a plug-in. When a file with a recognized MIME type is detected, the associated plug-in may be called by the client to perform a default action on the file. The default action on a file is typically limited to displaying or saving it. If the file is an executable file, the default action is typically limited to executing or saving it. Unrecognized file types usually have a default action of saving to the file system. Web browsers operate in a similar manner.

To help manage electronic message, filters are, often used. Filters are executable modules invoked when an electronic message matches specified criteria. For example, filters are used to detect and handle spam, to prevent the sending of files whose size exceeds the maximum the client is configured to handle, to log messaging activity, etc.

However, there are several disadvantages to the conventional electronic message processing. First, a plug-in to handle a specific file type must be present on the client system. Second, plug-ins must register themselves with the client system. That is, even if the plug-in exists, the client application (email, instant messenger, or web browser) can't use it, unless it is registered. This typically means that each plug-in must be aware of the client program it supports and be installed after the client program is installed. Third, although in some MIME type registries it's possible for a plug-in to register more than one action that it can perform on a file type, this is rarely done. Fourth, plug-ins operate on one attachment at a time. The client is not able to process them as a group even though the sender may have intended that they be considered as such. Fifth, handling file attachments happens on the client device. This is sometimes inefficient as some processing may require extensive memory or processor resources. For example, if a formatted text document is sent as an attachment to a mobile device, the displaying of the document may require memory and processor resources that exceed the capabilities of the mobile device. This document thus cannot be viewed.

In addition, conventional filters are controlled by the server administrator. Client users have no control of either the filters or the matching criteria used to trigger the invocation of a filter. They are also executed on the server before the client receives the message and attachments, i.e., there is no post-reception processing.

Accordingly, there exists a need for a method for providing user selectable electronic message action choices and processing. The method should allow services to be customized to the user and the electronic message. The method should integrate these services into existing electronic message interfaces. The method should also be centrally controlled to enable Internet service providers and business information technology administrators to easily add, advertise, and distribute new services. The present invention addresses such a need.

### SUMMARY OF THE INVENTION

In a method and system for providing user selectable electronic message action choices and processing, an electronic message for a client is received. Then, it is determined if the electronic message matches at least one criteria of a filter, where at least one action is associated with the filter. If so, a graphic associated with the action is displayed when the electronic message is viewed at the client, and the action is executed if the graphic is selected. In one embodiment, computer code for displaying the graphic is inserted into the electronic message. In this manner, services can be provided at the client without requiring a plug-in to be registered at the client. Additional functionality, services, and/or flexibility can be easily provided.

### BRIEF DESCRIPTION OF THE FIGURES

FIG. 1 illustrates a preferred embodiment of a system for providing user selectable electronic message action choices and processing in accordance with the present invention.

FIG. 2 is a flowchart illustrating a preferred embodiment of a method for providing user selectable electronic message action choices and processing in accordance with the present invention.

FIGS. 3 and 4 are flowcharts illustrating in more detail the steps performed by the mail server in the preferred embodiment of the method in accordance with the present invention when it receives an electronic message.

FIG. 5 is a flowchart illustrating in more detail the steps performed by the client in the preferred embodiment in the method in accordance with the present invention when the client receives the electronic message.

FIG. 6 is a flowchart illustrating in more detail the steps performed by the client and the mail server in the preferred embodiment of the method in accordance with the present invention in performing an action.

FIG. 7 is a diagram illustrating software components and database table relationships for the preferred embodiment of the method in accordance with the present invention.

FIG. 8 illustrates an example electronic message interface provided in accordance with the present invention.

FIG. 9 illustrates an example interface for configuring a filter in accordance with the present invention.

FIG. 10 illustrates an example interface for configuring an action in accordance with the present invention.

### DETAILED DESCRIPTION

The present invention provides a method for providing user selectable electronic message action choices and processing. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

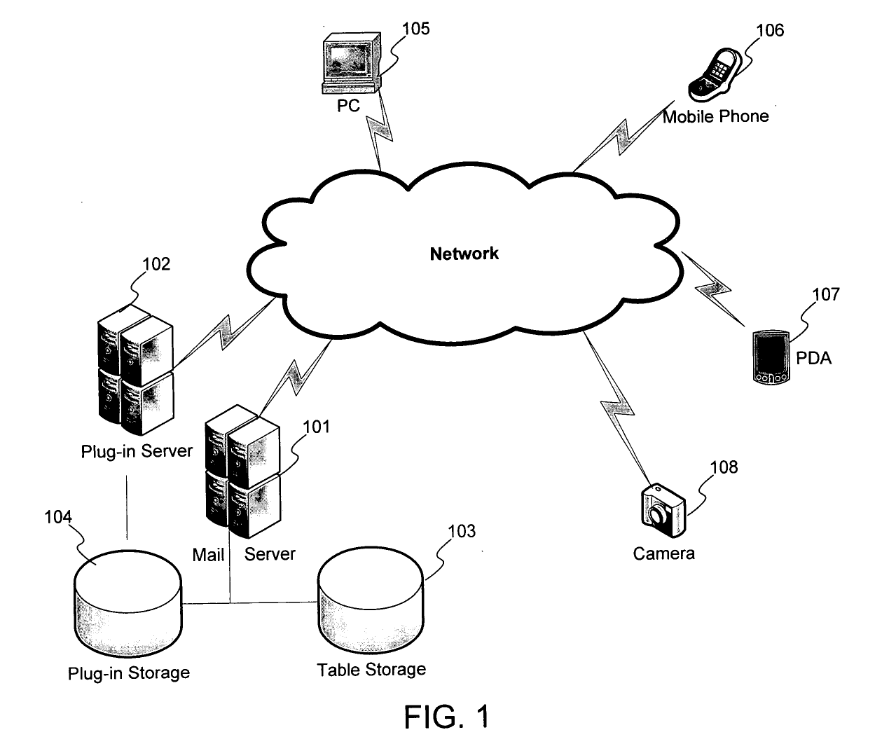

To more particularly describe the features of the present invention, please refer to FIGS. 1 through 10 in conjunction with the discussion below.

FIG. 1 illustrates a preferred embodiment of a system for providing user selectable electronic message action choices and processing in accordance with the present invention. The system comprises a mail server 101 networked with a client. The client can be a personal computer 105, a mobile phone 106, a personal digital assistant (PDA) 107, an image capture device 108 (such as a camera), or another other client capable of receiving electronic messages. The system further comprises a plug-in server 102 for managing plug-ins, a table storage 103 for storing data on user accounts, electronic messages, filters, actions associated with the filters, etc., and a plug-in storage 104. Although the mail server 101 and plug-in server 102 are illustrated as separate components, they can be parts of a single component as well. Also, although the table storage 103 and plug-in storage 104 are illustrated as being external to the servers 101-102, they can be internal to the servers 101-102 as well.

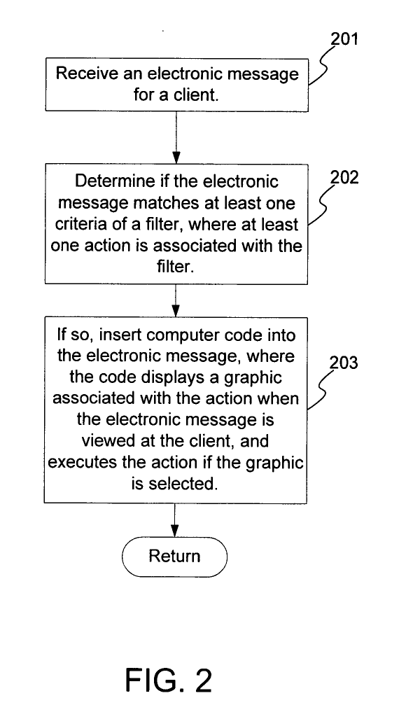

FIG. 2 is a flowchart illustrating a preferred embodiment of a method for providing user selectable electronic message action choices and processing in accordance with the present invention. First, an electronic message for a client is received, via step 201. Next, it is determined if the electronic message matches at least one criteria of a filter, where at least one action is associated with the filter, via step 202. Actions can include saving the file attachment, viewing the file attachment, sending the file attachment to others, etc. If so, then computer code is inserted into the electronic message to display a graphic associated with the action when the message is viewed at the client, and to execute the action if the graphic is selected, via step 203. The computer code can be of any type, such as Hypertext Markup Language (HTML). If more than one action is associated with the filter, then more than one graphic can be displayed, with each graphic being associated with one of the actions. For example, the graphics can be a plurality of buttons displayed as part of the electronic message. Each button is associated with an action, such as saving the file attachment, viewing the file attachment, etc. The graphic can also comprise icons, selectable text, menus, or any other viewable and selectable item. In this embodiment, the execution of the action includes the invocation of a plug-in at the plug-in server 102. The actions can be executed either on the client or redirected back to the mail server 101. Because the code for displaying the graphic is inserted into the electronic message, services can be provided at the client without requiring a plug-in to be registered at the client. Also, the filters and the actions associated with the filters can be customized. In this manner, additional functionality, services, and/or flexibility can be easily provided.

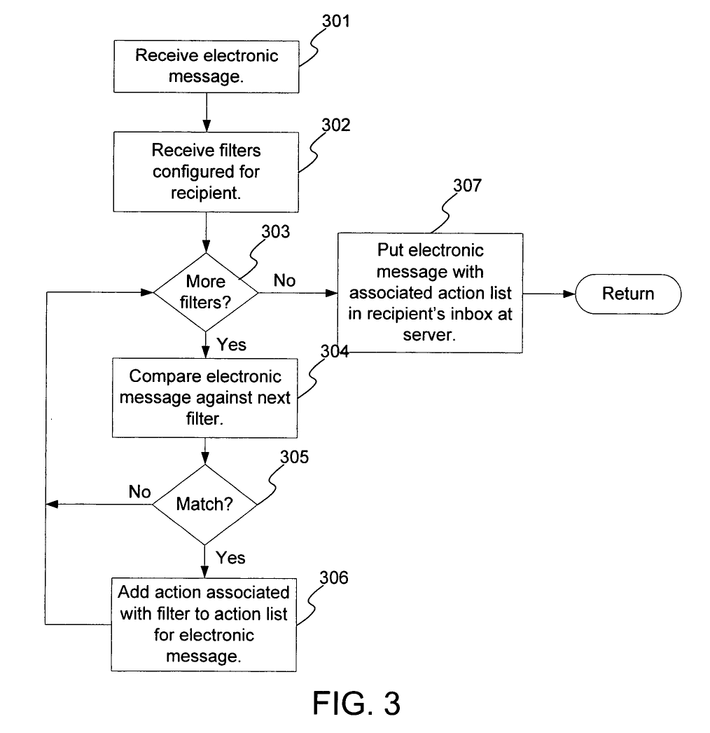

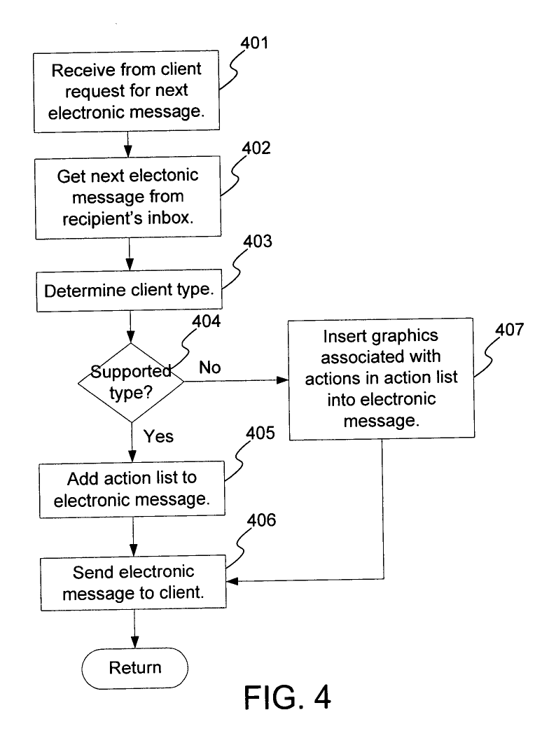

FIGS. 3 and 4 are flowcharts illustrating in more detail the steps performed by the mail server 101 in the preferred embodiment of the method in accordance with the present invention when it receives an electronic message. First, the mail server 101 receives the electronic message, via step 301. The mail server 101 then receives the filters configured for a user who is the recipient of the electronic message, via step 302. In this embodiment, the filters are stored in a filters table in the table storage 103 and can be associated with particular recipients. Each filter contains at least one criteria and one or more actions to be performed if the criteria are met. Each filter is then compared with the electronic message, via steps 303 and 304. If the electronic message matches the criteria in the filter, via step 305, the action associated with the filter is added to an action list for the electronic message, via step 306. Once the electronic message has been compared to all filters associated with the recipient, the electronic message, with its action list, is then put into the recipient's inbox at the mail server 101, via step 307.

As illustrated in FIG. 4, when the mail server 101 receives from a client a request for the next electronic message for the recipient, via step 401, it gets the next electronic message from the recipient's inbox on the mail server 101, via step 402. The mail server 101 then determines the client type, via step 403, e.g. PC, mobile phone, PDA, image capture device, etc. Next, it is determined if the client type is supported, via step 404. In this embodiment, a supported client is one customized to provide greater integration of the present invention with conventional message processing functionality, as described further below. If the client type is not a supported type, then code is inserted into the electronic message, via step 407, for displaying the graphics and for associating each graphic to one or more actions on the list as defined by the filters. The electronic message is then sent to the client, via step 406. For supported client types, greater integration of the message processing interface is possible. Thus, the action list is added to the electronic message, via step 405, with or without the need to add the graphics to be displayed as part of the electronic message. The graphics can be displayed elsewhere or in different manners, to facilitate greater ease of use. The electronic message is then sent to the client, via step 406, where the graphics are displayed when the electronic message is viewed.

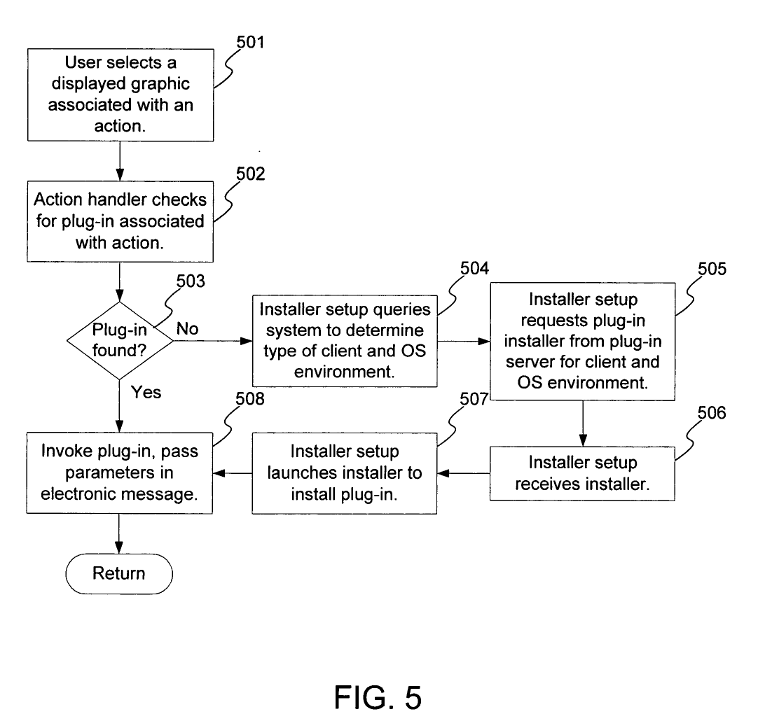

FIG. 5 is a flowchart illustrating in more detail the steps performed by the client in the preferred embodiment in the method in accordance with the present invention when the client receives the electronic message. Once a client receives the electronic message sent by the mail server 101, via step 406, the graphics are displayed when the electronic message is viewed. A user can then select one of the displayed graphics, via step 501, to execute the action associated with the graphic. An action handler at the client first checks for the plug-in associated with the action, via step 502. If the plug-in is found, via step 503, then it is invoked, via step 508. Parameters as defined by the action and the electronic message are passed to the plug-in. If the plug-in is not found, then an install setup at the client queries the client system to determine the type of client and the operating system (OS) environment, via step 504. The installer setup then requests the plug-in installer from the plug-in server 102 for the client type and OS environment, via step 505. The plug-in server 102 responds by retrieving the installer for the requested plug-in from the plug-in storage 104 and sending it to the client. Once the installer setup receives the installer, via step 506, it launches the installer to install the plug-in at the client, via step 507. Once the plug-in is installed, it is invoked, via step 508.

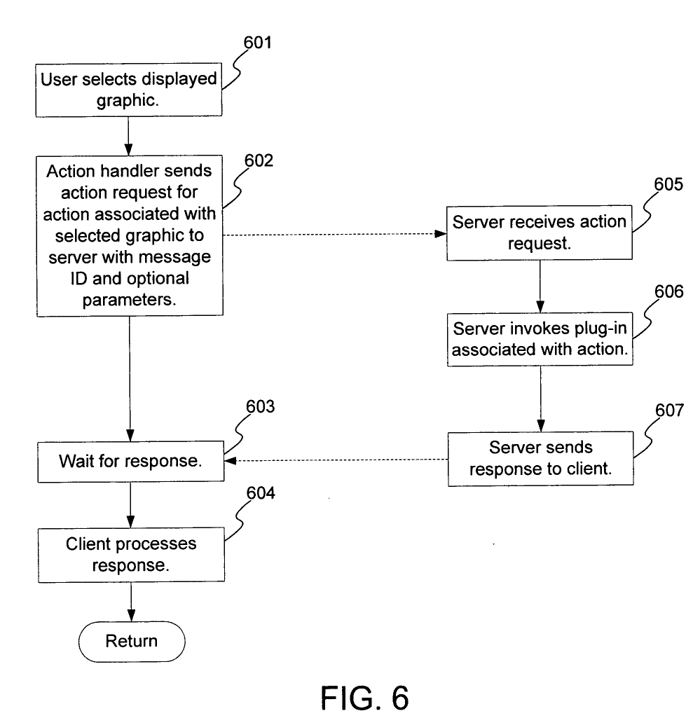

FIG. 6 is a flowchart illustrating in more detail the steps performed by the client and the mail server in the preferred embodiment of the method in accordance with the present invention in performing an action. First, the user selects a displayed graphic, via step 601. The action handler at the client then sends an action request for the action associated with the selected graphic to the mail server 101 with the message ID and any optional parameters, via step 602. The mail server 101 receives the action request, via step 605, invokes the plug-in associated with the action, via step 606, and sends the response to the client, via step 607. In the meantime, the client waits for the response from the mail server 101, via step 603. Once the response is received, the client processes the response, via step 604.

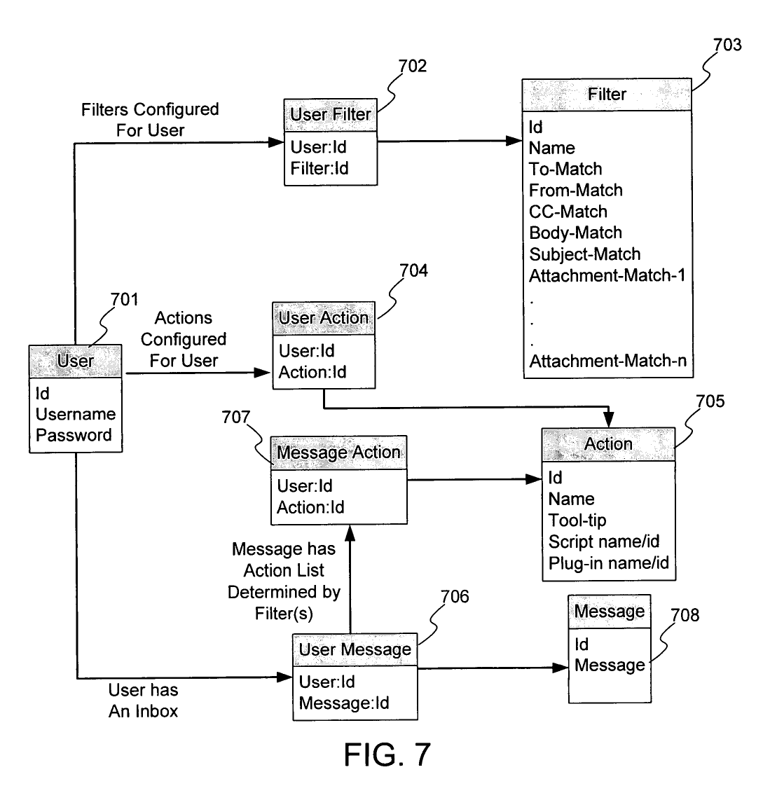

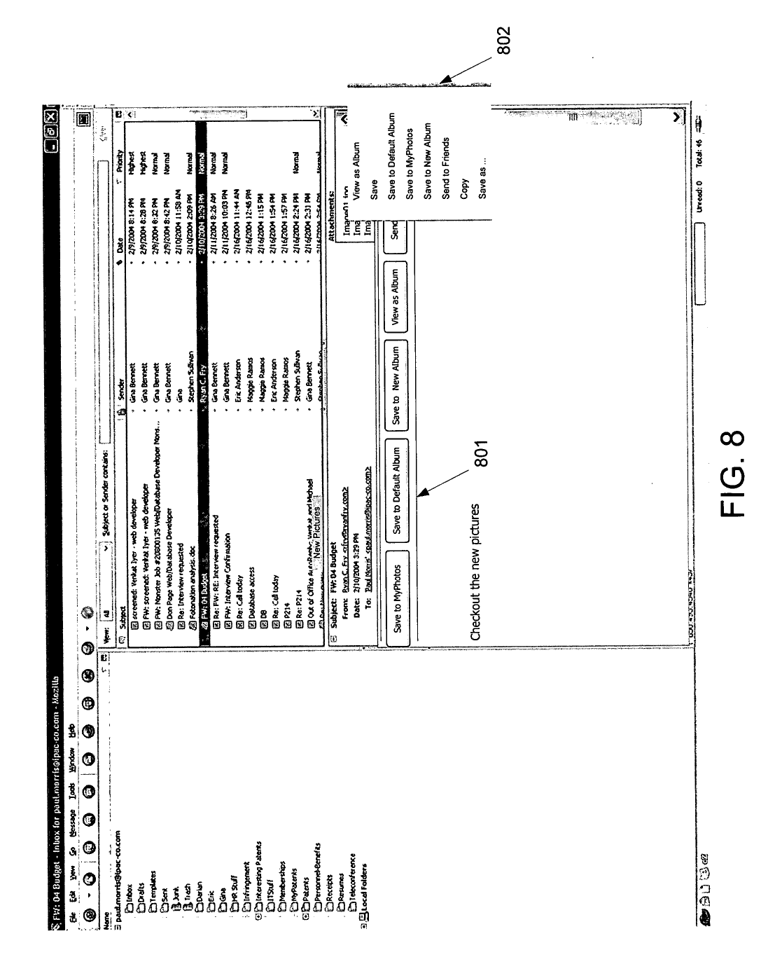

FIG. 7 is a diagram illustrating software components and database table relationships for the preferred embodiment of the method in accordance with the present invention. A user table 701 stores a user Id, user name, and password for each user. A user filter table 702 stores the user Id and the filter Id for the filters configured for each user. A filter table 703 stores the filters configured on the system, containing the filter Id, name, and the criteria. A user action table 704 stores the user Id and the action Id for the action configured for each user. An action table 705 stores the actions configured on the system, containing the action Id, name, tool-tip, script name, and plug-in name associated with this action, as explained further below with FIGS. 8 through 10. Each filter in the filter table 703 can associate its criteria with one or more actions in the action table 705. A user message table 706 stores the user Id and message Id of the user's messages, while the message table 708 stores the actual messages. Each message has an associated action list determined by the filters, as described above. The actions in the list are stored in a message action table 707. Each action in the list can be found in the action table 705. For each message belonging to the user that has an action list determined by the filter, the actions on the action list are made available to the user when viewing the message.

FIG. 8 illustrates an example electronic message interface provided in accordance with the present invention. Here, the mail server 101 had inserted code into the electronic message. This code displays a plurality of graphics in the form of buttons 801, each button associated with an action. For example, the displayed electronic message has digital images files as attachments. Various actions can be performed on these image files, including “Save to MyPhotos”, “Save to Default Album”, etc. Each of these actions are associated with a button 801. The user can select which action is to be taken on the image files by selecting the corresponding button. Also, if an individual image file is selected, a context menu 802, giving specific actions that can be performed on the image file, is displayed. The action list for an electronic message can be customized on a per user basis. Thus, in this example, if the same electronic message is sent to two different users, the buttons displayed for one user can be different from the buttons displayed for another user.

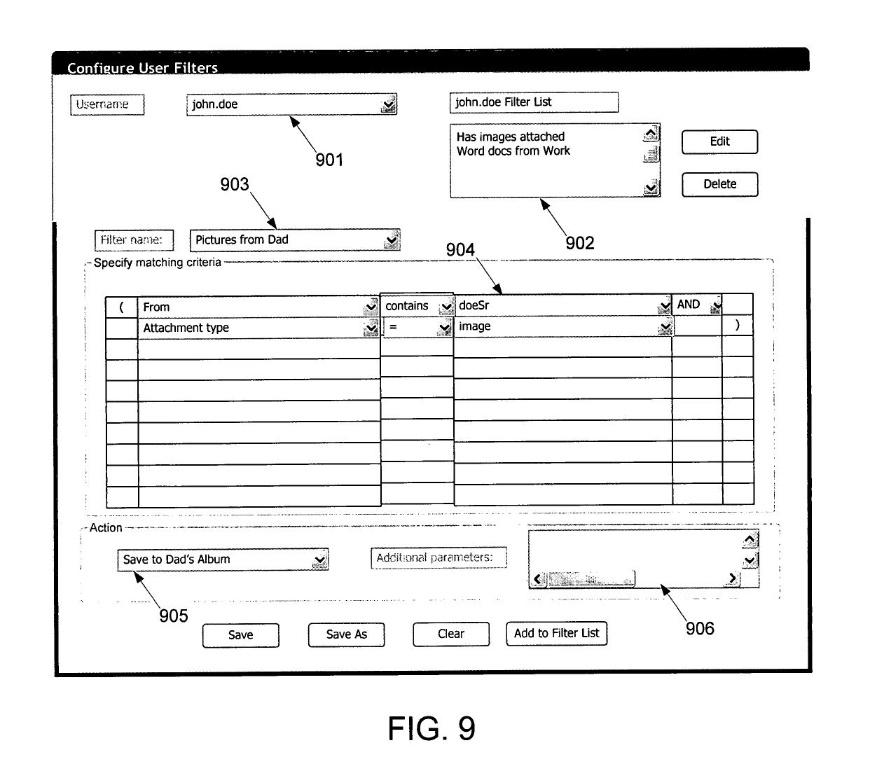

FIG. 9 illustrates an example interface for configuring a filter in accordance with the present invention. Each filter can be customized on a per user basis, thus, a field in the interface is the username 901. The filter list fields 902 lists the existing filters already configured for the user. Below this are fields to configure a new filter or to modify an existing filter. The filter name is set forth in the filter name field 903. A drop down menu is available to display existing filters or a new name can be entered for a new filter. The user then specifies the matching criteria for the filter in the criteria field 904. The user further specifies the action associated with the filter in the action field 905. A drop down menu is available to display actions already defined for the user. Additional parameters can be configured in the additional parameters field 906. For example, the action named “Save to Dad's Album” is selected to be the action associated with the filter named “Pictures from Dad”. When the “From” field of a message contains “doeSr” and the attachment type is an image, then the action named “Save to Dad's Album” is added to the electronic message's action list.

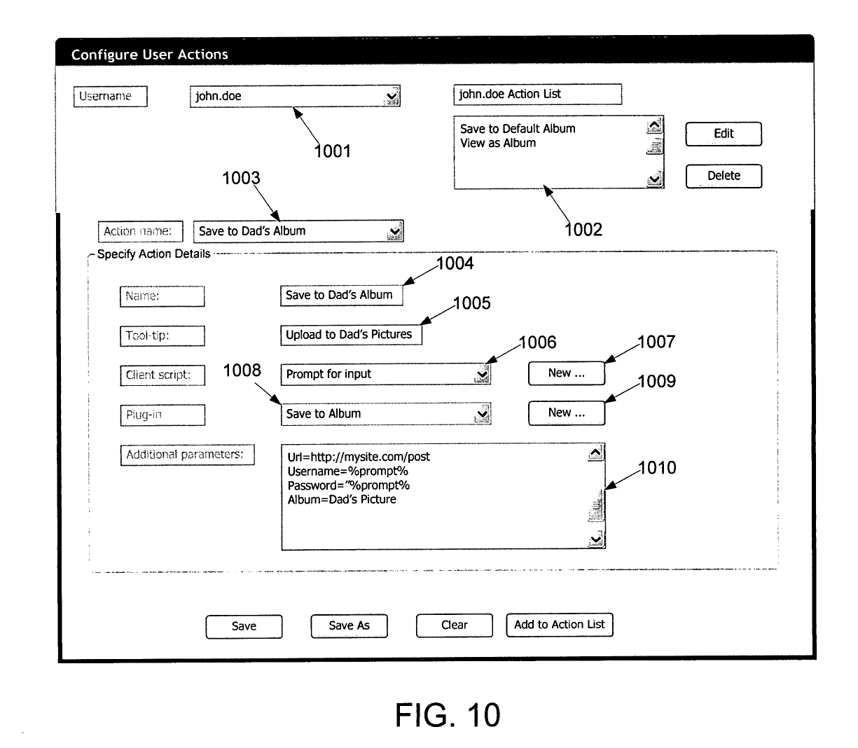

FIG. 10 illustrates an example interface for configuring an action in accordance with the present invention. Since each action can be customized on a per user basis, a field in the interface is the username 1001. The action list fields 1002 lists the existing actions already configured for the user. Below this are fields to configure a new action or to modify an existing action. The name for this action is in the action name field 1003. A drop down menu is available to display existing actions or a new name can be entered for a new action. The user then specifies the action details. These details can include parameters such as the name 1004 to be displayed on the button, the tool-tip 1005 to be displayed as the context menu 802, the client script 1006 to be run when the button is selected, the plug-in 1008 to be executed when the button is selected, and any additional parameters 1010. New clients and new plug-ins can be configured by selecting the “New . . . ” button 1007 and 1009, respectively. In the illustrated example, for the action named “Save to Dad's Album”, “Save to Dad's Album” is to be displayed on the button. The tool-tip named “Upload to Dad's Pictures” is to be displayed in the context menu 802. When the button or the tool-tip is selected, the client script “Prompt for input” is first displayed. The user will be prompted to provide the Username and Password, as defined by the additional parameters in the additional parameter field 1010. Once the user provides these inputs, the plug-in named “Save to Album” is executed, with the file attachments of the electronic message being saved to the album named “Dad's Picture”, as defined by the additional parameters.

Although the preferred embodiment is described above with the filtering function performed at the mail server 101, one of ordinary skill in the art will understand that these functions can also be performed at the client without departing from the spirit and scope of the present invention. Here, the sender of the electronic message can be given control over the filtering function.

Although the preferred embodiment is described above with the mail and plug-in servers 101-102, one of ordinary skill in the art will understand that the present invention can also be implemented in a peer-to-peer network environment, with the filtering function being performed by client electronic message applications. Here, a plug-in server could exist at each client, or a group of clients could share one or more plug-in servers. Further, if the network comprises relay systems, where the electronic message travels through multiple relay servers, each relay server between the sending client and the receiving client could filter the electronic messages and associate actions with the electronic message.

A method and system for providing user selectable electronic message action choices and processing has been disclosed. With the present invention, an electronic message for a client is received. Then, it is determined if the electronic message matches at least one criteria of a filter, where at least one action is associated with the filter. If so, a graphic associated with the action is displayed when the electronic message is viewed at the client, and the action is executed if the graphic is selected. In one embodiment, computer code for displaying the graphic is inserted into the electronic message. In this manner, services can be provided at the client without requiring a plug-in to be registered at the client. Also, the filter and the actions associated with the filters can be customized. In this manner, additional functionality, services, and/or flexibility can be easily provided. The present invention integrates these services into existing electronic message interfaces. The method and system is also centrally controlled to enable Internet service providers and business information technology administrators to easily add, advertise, and distribute new services.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for providing user selectable electronic message action choices and processing, comprising the steps of:
(a) receiving an electronic message for a client;
(b) determining if the electronic message matches at least one criteria of a filter, wherein at least one action is associated with the filter; and
(c) if the electronic message matches the criteria, displaying a graphic associated with the action when the electronic message is viewed at the client and executing the action if the graphic is selected.

2. The method of claim 1, wherein the determining step (b) further comprises:
(b1) adding the action associated with the filter to an action list for the electronic message, if the electronic message matches the criteria.

3. The method of claim 2, wherein the adding step (b1) comprises:
(b1i) receiving a plurality of filters configured for a recipient of the electronic message;
(b1ii) comparing the electronic message against criteria of each of the plurality of filters;
(b1iii) for each filter with criteria matching the electronic message, adding an action associated with the filter to an action list for the electronic message; and
(b1iv) placing the electronic message with the action list in the recipient's inbox.

4. The method of claim 2, wherein the displaying step (c) comprises:
(c1) inserting computer code into the electronic message if the electronic message matches the criteria, wherein the computer code displays the graphic associated with the action when the electronic message is viewed at the client and executes the action if the graphic is selected.

5. The method of claim 4, wherein the inserting step (cl) comprises:
(c1i) receiving from the client a request for the electronic message;
(c1ii) obtaining the electronic message from the recipient's inbox; and
(c1iii) inserting a graphic associated with each action in the action list into the electronic message.

6. The method of claim 2, wherein the displaying step (c) comprises:
(c1) determining that the client is a supported client;
(c2) adding the action list to the electronic message; and
(c3) sending the electronic message to the client.

7. The method of claim 1, further comprising:
(d) receiving a selection of the graphic;
(e) checking for a plug-in associated with the action at the client; and
(f) invoking the plug-in, if the plug-in is found.

8. The method of claim 7, further comprising:
(g) requesting the plug-in from a plug-in server, if the plug-in is not found;
(h) receiving the plug-in from the plug-in server;
(i) installing the received plug-in; and
(j) invoking the plug-in.

9. The method of claim 1, further comprising:
(d) receiving a selection of the graphic;
(e) sending an action request for the action associated with the selected graphic to a server; and
(f) processing a response to the request from the server.

10. The method of claim 9, further comprising:
(g) receiving the action request by the server;
(h) invoking a plug-in associated with the action; and
(i) sending a response to the action request to the client.

11. The method of claim 1, wherein the criteria of the filter are customizable for a recipient.

12. The method of claim 1, wherein the action is customizable for a recipient.

13. The method of claim 1, wherein the determining step (b) is performed at a mail server.

14. The method of claim 1, wherein the determining step (b) is performed at the client.

15. The method of claim 1, wherein the determining step (b) is performed at a relay server.

16. The method of claim 1, wherein the client comprises one or more of a group consisting of:
a cellular phone;
a personal computer;
a personal digital assistant; and
an image capture device.

17. The method of claim 1, wherein the electronic message comprises a file attachment, wherein the file attachment comprises an image file.

18. A computer readable medium with program instructions for providing user selectable electronic message action choices and processing, comprising the instructions for:
(a) receiving an electronic message for a client;
(b) determining if the electronic message matches at least one criteria of a filter, wherein at least one action is associated with the filter;
(c) if the electronic message matches the criteria, displaying a graphic associated with the action when the electronic message is viewed at the client and executing the action if the graphic is selected.

19. The medium of claim 18, wherein the determining instruction (b) further comprises:
(b1) adding the action associated with the filter to an action list for the electronic message, if the electronic message matches the criteria.

20. The medium of claim 19, wherein the adding instruction (b1) comprises:
(b1i) receiving a plurality of filters configured for a recipient of the electronic message;
(b1ii) comparing the electronic message against criteria of each of the plurality of filters;
(b1iii) for each filter with criteria matching the electronic message, adding an action associated with the filter to an action list for the electronic message; and
(b1iv) placing the electronic message with the action list in the recipient's inbox.

21. The medium of claim 19, wherein the displaying step (c) comprises:
(c1) inserting computer code into the electronic message if the electronic message matches the criteria, wherein the computer code displays the graphic associated with the action when the electronic message is viewed at the client and executes the action if the graphic is selected.

22. The medium of claim 21, wherein the inserting instruction (c1) comprises:
(c1i) receiving from the client a request for the electronic message;
(c1ii) obtaining the electronic message from the recipient's inbox; and
(c1iii) inserting a graphic associated with each action in the action list into the electronic message.

23. The medium of claim 19, wherein the displaying step (c) comprises:
(c1) determining that the client is a supported client;
(c2) adding the action list to the electronic message; and
(c3) sending the electronic message to the client.

24. The medium of claim 18, further comprising:
(d) receiving a selection of the graphic;
(e) checking for a plug-in associated with the action at the client; and
(f) invoking the plug-in, if the plug-in is found.

25. The medium of claim 24, further comprising:
(g) requesting the plug-in from a plug-in server, if the plug-in is not found;
(h) receiving the plug-in from the plug-in server;
(i) installing the received plug-in; and
(j) invoking the plug-in.

26. The medium of claim 18, further comprising:
(d) receiving a selection of the graphic;
(e) sending an action request for the action associated with the selected graphic to a server; and
(f) processing a response to the request from the server.

27. The medium of claim 26, further comprising:
(g) receiving the action request by the server;
(h) invoking a plug-in associated with the action; and
(i) sending a response to the action request to the client.

28. The medium of claim 18, wherein the criteria of the filter are customizable for a recipient.

29. The medium of claim 18, wherein the action is customizable for a recipient.

30. The medium of claim 18, wherein the determining instruction (b) is performed at a mail server.

31. The medium of claim 18, wherein the determining instruction (b) is performed at the client.

32. The medium of claim 18, wherein the determining instruction (b) is performed at a relay server.

33. The medium of claim 18, wherein the client comprises one or more of a group consisting of:
a cellular phone;
a personal computer;
a personal digital assistant; and
an image capture device.

34. The medium of claim 18, wherein the electronic message comprises a file attachment, wherein the file attachment comprises an image file.

35. A system, comprising:
a storage medium for storing:
a plurality of filters, each filter comprising at least one criteria, and
a plurality of actions, each action capable of being associated with one of the plurality of filters; and
a mail server, wherein the mail server:
receives an electronic message for a client,
determines if the electronic message matches the criteria of one of the plurality of filters, and
if the electronic message matches the criteria of the filter, displaying a graphic associated with the action associated with the matching filter when the electronic message is viewed at the client and executing the action if the graphic is selected.

36. The system of claim 35, further comprising:
a plug-in server; and
a plurality of plug-ins stored in the storage medium, wherein each plug-in is capable of being invoked when one of the plurality of actions is executed.

37. A system, comprising:
a storage medium for storing:
a plurality of filters, each filter comprising at least one criteria, and
a plurality of actions, each action capable of being associated with one of the plurality of filters; and
an electronic mail application, wherein the application:
determines if an electronic message matches the criteria of one of the plurality of filters, and
if the electronic message matches the criteria, displaying a graphic associated with the action associated with the matching filter when the electronic message is viewed and executing the action if the graphic is selected.

38. The system of claim 37, further comprising:
a plug-in server; and
a plurality of plug-ins stored in the storage medium, wherein each plug-in is capable of being invoked when one of the plurality of actions is executed.
